(19) United States
(12) Patent Application Publication
(10) Pub. No.: US 2013/0004733 A1
(43) Pub. Date: Jan. 3, 2013

(54) METHOD TO REDUCE METAL PICK-OFF FROM EDGES OF METALLIZED BIAXIALLY ORIENTED FILMS

(75) Inventors: Masahito IWASHITA, West Warwick, RI (US); Christopher S. Curry, Exeter, RI (US); Will E. Nunn, Carolina, RI (US); Eric M. Livsey, Coventry, RI (US)

(73) Assignee: TORAY PLASTICS (AMERICA), INC., N. Kingstown, RI (US)

(21) Appl. No.: 13/537,491

(22) Filed: Jun. 29, 2012

Related U.S. Application Data
(60) Provisional application No. 61/503,514, filed on Jun. 30, 2011.

(51) Int. Cl. B21B 1/08; B32B 3/02

(52) U.S. Cl. 428/192; 72/199

(57) ABSTRACT

Methods and equipment to reduce or eliminate metal edge-pick-off defects in freshly metallized polymeric film rolls are disclosed. The method may include the formation of a “raised edge” such that the ingress of air and/or oxygen gas into the ends of the wound freshly-metallized roll is blocked or impeded, thus reducing oxidation of the metal. This method significantly reduces the amount of metal pick-off defects and resulting quality and productivity losses due to scrapping of such defective metallized film.

### CROSS-REFERENCE TO RELATED APPLICATION

This application claims the benefit of U.S. Provisional Application No. 61/503,514, filed Jun. 30, 2011, the entirety of which is incorporated herein by reference.

### FIELD OF THE INVENTION

This invention relates to a method to reduce metal loss and metal damage resulting from transfer of metal from one side of a substrate to the opposite side. This is particularly relevant to newly vacuum-metallized multi-layer heat sealable biaxially oriented polypropylene (BOPP) films prior to formation of a protective metal oxide layer upon the vapor-deposited metal, although the method could be applicable to other polymer substrates used for high speed vapor-deposition of metal.

### BACKGROUND OF THE INVENTION

Biaxially oriented polypropylene (BOPP) films used for packaging, decorative, and label applications often perform multiple functions. It must perform in a lamination to provide printability, transparent or matte appearance, or slip properties; it sometimes must provide a heat sealable layer for bag forming and sealing, or a layer that is suitable for receiving an adhesive either by coating or laminating. BOPP films are also used as substrate films for receiving gas barrier layers; in popular embodiments, the gas barrier layer is an inorganic metal such as aluminum, which is vapor-deposited upon the BOPP substrate inside a vacuum chamber under high speed conditions.

For aluminum-metallized BOPP films, it is desirable for the metallized film to have a certain optical density, uniformity of metal appearance, and high gloss. These attributes provide consistent and functional gas barrier properties and pleasing aesthetic appearance. Damage to the metal layer, whether by scratching, metal “splashing”, static discharges, and metal pick-off (perhaps due to poor metal adhesion), can directly impact both these attributes, resulting in poorer gas barrier and a poor aesthetic appearance. In particular, one phenomenon affecting metal quality is known as metal “edge pick-off” (EPO). Metal pick-off is a type of metal damage whereby multiple small spots or areas of metal are transferred from the metal receiving surface to the opposite surface (non-metal receiving surface) when the metallized film is wound in roll form.

Remedies to alleviate the effects of EPO have been primarily along the lines of the metallizing machine's process conditions. Lowering winding tensions, for example, can help reduce edge pick-off effects, particularly near the core (or start of rewinding after metallizing), but nevertheless, have only had limited effectiveness. Choice of antiblock particles (size, type, and amount) in the heat sealable layer of the substrate film (basefilm) can also help alleviate the severity of EPO, but does not eliminate it. Optical density (OD) can have an effect on edge pick-off severity with lower OD reducing EPO, but does not eliminate EPO. In spite of varying process conditions of the metallizing chamber, only limited reduction of EPO has been achieved with heat sealable BOPP substrates.

U.S. Pat. No. 7,807,232 describes the use of a plasma treater mounted inside the vacuum metallizing chamber after the metal deposition station but prior to the rewinding section. The plasma treater is placed to discharge-treat the freshly metallized surface (aluminum surface). By using oxygen gas in the plasma treater, high energy oxygen ions impinge upon the aluminum metal surface, producing a protective aluminum oxide layer upon the metal layer's surface prior to rewinding. This type of metal “passivation” treatment has been found to reduce metal pick-off (“peel-off”) of metallized substrates. However, this solution requires capital expenditure and requires that enough space exists within the metallization chamber to accommodate this treater.

German Patent DE 4308632 B4 describes the use of a plasma treater mounted inside the vacuum metallizing chamber in a position that is post-metal deposition station and pre-rewinding station whereby the plasma discharge is directed towards the metallized surface. Again, the use of this method requires a large capital expenditure and assumes that enough space exists in the chamber to retro-fit such equipment.

Japan Patent 2000-6297 also discloses the use of a plasma treatment system mounted inside the vacuum metallizing chamber after the metal deposition station and prior to the rewinding section (or prior to the metallized surface from contacting any other machine rollers, etc.). The plasma discharge is directed towards the metallized layer and forms a thin layer of aluminum oxide upon the aluminum layer so as to improve gas barrier properties. This solution also requires capital expenditure and designing the vacuum chamber with enough space to accommodate this equipment.

We seek to address the above issues of reducing or eliminating “edge pick-off” metal damage and improve productivity, quality, gas barrier, and metal appearance using a simple, cost-effective method that does not require the use of plasma treaters or other capital-intensive equipment. The described solution may not require significant modifications or accommodations for designing space within the metallizing chamber to accommodate said solution and the inventors believe that the inventive solution can be readily retro-fitted to existing vacuum metallizing chambers.

### SUMMARY OF THE INVENTION

The present invention provides a method to significantly reduce the amount and severity of metal edge pick-off in freshly metallized polymeric films. This lowers overall manufacturing costs and waste. The inventive solution involves producing a “raised edge” on the edges of the substrate roll after metallization and during rewinding. This “raised edge” prevents the ingress of oxygen gas into the ends of the metallized roll upon venting, thus preventing oxidation of the metal and pick-off of the metal onto the heat sealable layer during the venting process. Upon slitting of the roll, edge pick-off defects are significantly reduced or eliminated.

A method of reducing edge pick-off on a metallized polymeric film may include creating a raised edge on at least one edge of a metallized polymeric film wherein edge pick-off severity is rated 3.0 or less (per rating scale described in “Test Methods”: 1.0 to 4.0 wherein 1.0 is “Excellent” with no pick-off; 2.0 is “Good”; 3.0 is “Fair”; and 4.0 is “Poor” indicating severe pick-off); and an acceptable edge pick-off width is 2.5 inches (63.5 mm) or less. The raised edge may be 0.5-3.0 mm in height above the non-raised surface of the metallized polymeric film roll. The metallized polymeric film may include a metal layer wherein the metal layer may have an optical density of 1.5-5.0.

The raised edge may be created by numerous methods including, but not limited to: mechanical knurling devices, electrostatic knurling devices, a slotted edge masking design, tape or tapes placed around the circumference of the metallizer's cooling drum; and/or tape or tapes or bands placed around the circumference of the rewinding core prior to rewinding metallized film upon said core.

An embodiment of a metallized polymeric film with reduced edge pick-off may include a polymer layer, a metal layer on the polymer layer, and a raised edge on at least one edge of the metallized film layer, wherein the metallized film layer has an edge pick-off severity of 3.0 rating or less, and an edge pick-off width of 2.5 inches (63.5 mm) or less.

An embodiment of a method of reducing edge pick-off on a metallized polymeric film may include creating a raised edge on at least one edge of a metallized polymeric film. The edge pick-off severity may be 3.0 rating or less, and edge pick-off width may be is 2.5 inches or less.

The raised edge may be 0.5-3.0 mm in height above a non-raised surface of the metallized polymeric film roll. The metallized polymeric film may include a metal layer having an optical density of the metal layer is 1.5-5.0.

Creating the raised edge may include placing tape around a circumference of a cooling drum, or placing a tape or strip around a circumference of a rewinding core. The raised edge may be created using a slotted edge masking plate, by mechanical knurling, or by static electricity knurling.

Additional advantages of this invention will become readily apparent to those skilled in the art from the following detailed description, wherein only the preferred embodiments of this invention is shown and described, simply by way of illustration of the best mode contemplated for carrying out this invention. As will be realized, this invention is capable of other and different embodiments, and its details are capable of modifications in various obvious respects, all without departing from this invention. Accordingly, the examples and description are to be regarded as illustrative in nature and not as restrictive.

### BRIEF DESCRIPTION OF THE DRAWINGS

The novel features which are characteristic of the present invention are set forth in the appended claims and examples. However, the invention's preferred embodiments, together with further objects and attendant advantages, will be best understood by reference to the following detailed description taken in connection with the accompanying figures in which:

FIG. 1A is an illustration showing the severity of edge pick-off in a hard winding, which occurs near the core of a film roll;

FIG. 1B is an illustration showing the severity of edge pick-off in a soft winding, which occurs in outside windings of a film roll;

FIG. 1C is a photograph of actual metal edge pick-off from a metallized film sheet sample as seen on a light table;

FIG. 2 is an illustration showing how formation of “Raised Edge” prevents the ingress of air between the windings to minimize edge pick-off;

FIG. 3 is an illustration showing placement of tape on a metallizer's cooling drum to produce a “Raised Edge” on a film roll;

FIG. 4 is photographs showing actual placement of tapes on each end of the cooling drum in a metallizing chamber;

FIG. 5A is a photograph of a cooling drum showing the formation of a “Raised Edge” from film wrinkle induced by tape;

FIG. 5B is a photograph of the drive side of a cooling drum showing the formation of a “Raised Edge” from film wrinkle induced by tape;

FIG. 5C is a photograph of a cooling drum showing a “Raised Edge” and a “Clear Edge”;

FIG. 6 is a photograph of a layer of metallized film on a light table illustrating the regions showing: clear unmetallized edge; edge pick-off area before the “raised edge”; raised edge region; and non-edge pick-off region after the raised edge region;

FIG. 7 is an illustration of a masking design with a slotted end plate for “Raised Edge” formation;

FIG. 8 is an illustration of a slotted end plate masking on a metallized film with a “Sacrificial Strip”;

FIG. 9A is a schematic view of the “raised edge” formed by the “sacrificial strip” metallization using the embodiment of a slotted end plate masking design.

FIG. 9B is a photograph of a “sacrificial strip” on one end of a rewound metallized film roll;

FIG. 10A is a photograph of a knurl patterns for 3 different knurl wheels;

FIG. 10B is a photograph of a knurl wheel with accompanying backing roll mounted inside the vacuum metallizing chamber between the rewinding section and the cooling drum where metal deposition upon the film substrate occurs;

FIG. 11A is a photograph of knurl wheel impression patterns made on pressure-sensitive indicating paper;

FIG. 11B is a photograph showing the elimination of metal edge pick-off damage using the “raised edge” formed by a mechanical knurl wheel; and

FIG. 12 is a schematic of a cross-sectional view of the interior of a vacuum metallizing chamber showing the interior lay-out of a typical metallizer, the position of the unwind section, rewind section, coating (or deposition) chamber, aluminum wire, cooling drum, ceramic boats, aluminum vapor cloud, film substrate path.

### DETAILED DESCRIPTION OF THE INVENTION

Described are methods and equipment to reduce metal loss and metal damage resulting from transfer of metal from one side of a substrate to the opposite side. This is particularly relevant to newly vacuum-metallized multi-layer heat sealable biaxially oriented polypropylene (BOPP) film substrates prior to the formation of a protective metal oxide layer upon the vapor-deposited metal, although the method could be applicable to other polymer substrates used for high speed vapor-deposition of metal. In particular, the metal damage/loss is seen with aluminum deposition upon BOPP, and on the edges of the master roll (aka “edge pick-off”). Such metal damage results in quality rejections and loss of productivity. Disclosed herein is a method to reduce said metal damage and improve quality and productivity.

This “pick-off” is particularly seen with heat sealable BOPP films in which the amorphous, low crystallinity, low melting point coextruded heat seal resin tends to have an affinity to the freshly deposited unoxidized aluminum metal and selectively removes the metal from the metal receiving surface. The appearance of the metallized film—when seen on a light table or microscope—is often described as a “starry night” appearance, showing a multiplicity of pin windows. In severe cases of metal pick-off, the loss of metal can be measured as a change in optical density when compared to pristine metal appearance. Such an appearance impacts both gas barrier (makes gas barrier worse) and aesthetic appearance. “Edge pick-off” (or EPO) is a type of metal pick-off in which a large degree of metal pick-off is seen specifically on the edges of the metallized master roll whereby the severe metal pick-off is registered within a band along each edge of the wound roll. The width of the edge pick-off band can range from an inch or two, to as much as 6-10 inches (ca. 15-25 cm) per side. As the width and severity of the metal damage/pick-off can be significant, productivity yield losses can be high as many end-use customers do not want to use such film and so such film must be slit off and discarded; thus, the program yield for such a roll is lowered and the non-conforming areas of the metallized roll must be programmed-out and discarded. This results in higher waste and cost.

Aluminum oxide (Al₂O₃) readily forms upon aluminum metal in the presence of oxygen and is a protective, hard, stable metal oxide. In fact, aluminum oxide—or alumina—is used industrially as an abrasive owing to its hardness. Aluminum oxide's durability and stability is responsible for the resistance of metallic aluminum to weathering. Metallic aluminum is very reactive with atmospheric oxygen and a thin passivation layer of aluminum oxide forms on any exposed aluminum metal surface. This layer protects the metal from further oxidation. In comparison to aluminum metal, aluminum oxide is much harder, having a Mohs hardness value of typically 9 (Vickers hardness ca. 1100-1440 kg/mm²) versus relatively soft aluminum metal at about 2.5-3 (Vickers hardness ca. 17 kg/mm²).

The process of physical vapor-deposition of aluminum upon a substrate is well-known in the art and occurs within a vacuum chamber in which air (and its oxygen gas component) is evacuated. In essence, a roll of a flexible polymeric substrate (including but not limited to: biaxially or monoaxially or blown or cast polypropylene-based films, biaxially oriented crystalline and amorphous-comprising polyethylene terephthalate-based films, polyamide-comprising films, and biaxially or monoaxially or blown or cast polyethylene-based films) is placed within the unwinding section of a metallizing chamber. The chamber is closed and the air within is pumped out to a certain vacuum level. The metallizing machine is started and the film substrate is unwound and conveyed into the deposition section of the chamber. The film substrate typically passes over a row or series of ceramic “boats” in which a metal wire—typically and preferably aluminum—is in contact with the boats' upper surface. The ceramic boats are aligned such that they are in parallel with and cover the transverse width of the substrate film. High electrical current is passed through the ceramic boats, generating enough heat to vaporize the aluminum wire in contact with said boats; this then generates a cloud of vaporized aluminum metal. This vaporized metal condenses upon the film substrate passing over the boats, forming a thin aluminum metal layer upon said substrate.

Generally, the film substrate is supported by a cooling drum during the deposition process to help prevent the polymeric film substrate from melting or breaking due to the high heat load of the condensing metal vapor. This aluminum metal-coated film substrate is then rewound back into roll form in the rewinding section of the machine. (FIG. 12 is a schematic illustrating the basic layout of a metallizing chamber's interior.) As the described process takes place in a vacuum wherein air and oxygen gas, and moisture vapor, have been removed, the deposited aluminum layer is substantially pure aluminum metal with no aluminum oxide formed. Upon completion of metallizing the substrate basefilm roll and rewinding the metallized roll, the chamber is “vented”—i.e. the pressure within the vacuum chamber is restored to ambient atmospheric pressure by allowing ambient air back into the chamber—and the metallized roll is removed for further processing such as slitting.

Without being bound by any theory, it is hypothesized that when the freshly vacuum-metallized roll within the evacuated metallizing chamber is vented, the ingress of air (which contains oxygen gas) into the wound ends of the roll immediately oxidizes the aluminum metal in that area of the roll to aluminum oxide. As the oxidation reaction is exothermic, heat is generated at the ends of the rolls (which are the edges of the film), which can in turn, “activate” the low melting point, relatively amorphous, heat sealable layer of the substrate film. This then causes an affinity for the metal to transfer from the metal receiving layer to the heat sealable layer. This, in turn, causes the metal pick-off appearance along each edge of the film when it is unwound on a slitting machine. It has been noted that with non-heat-sealable BOPP or other non-sealable polymer substrates, edge pick-off (EPO) effects are minimal. EPO is particularly prone to heat-sealable substrates which are designed with a low melting point, low T_{g}, amorphous polymer that is in contact with the metal layer when wound in roll form.

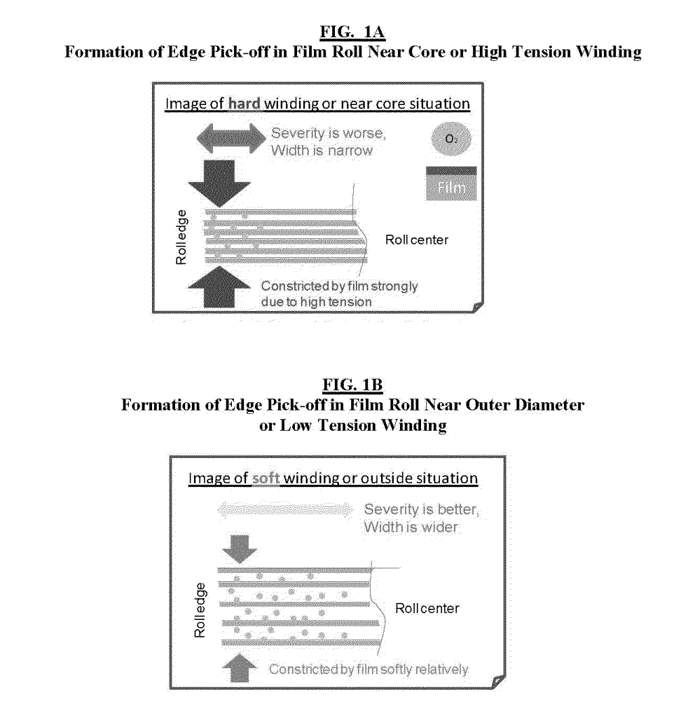

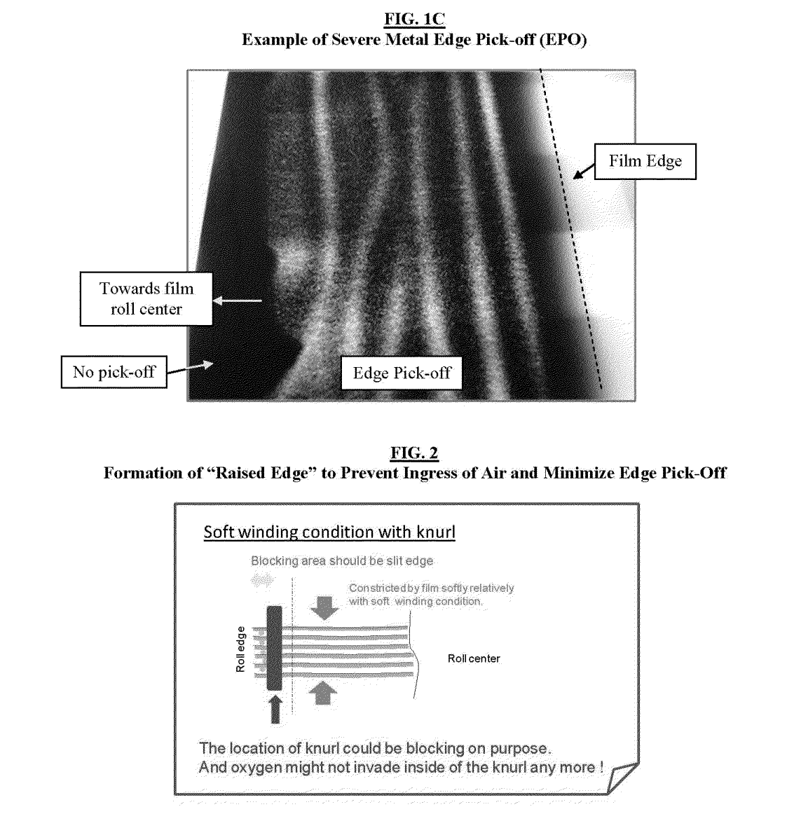

FIG. 1A is a representational view schematic of the metallized film layers near the core of a wound roll of metallized film after vacuum deposition of metal. The metal edge pick-off is represented by the small dots near the indicated edge of the wound roll. Near the core of the roll, edge pick-off is noted to be generally more severe, but narrower in width. This type of edge pick-off can also be seen when rewinding the film under high tension conditions (also known as “hard winding”).

FIG. 1B is a representational view schematic of the metallized film layers at the outer diameter of the wound roll of metallized film after vacuum deposition of metal. The metal edge pick-off is represented by the small dots. Near the outer diameter of the roll (far away from the core layers), edge pick-off is noted to be generally less severe, but wider in width. This type of edge pick-off can also be observed when rewinding the film under lower tension conditions (also known as “soft winding”).

FIG. 1C is a picture of actual metal edge pick-off from a metallized film sheet sample as seen on a light table. This is an example of severe edge pick-off.

To prevent or control the amount and severity of edge pick-off damage, the describe method relies upon the purposeful formation of a controlled wrinkle or “raised edge” in one or both ends of the wound film roll. Essentially, the “raised edge” is a wrinkle in the film substrate that occurs in the same machine direction location such that the wrinkle builds up on the rewinding roll with each successive layer of film that is rewound. This wrinkle forms a stiff, firm “raised edge”. The position of the “raised edges” can be placed as desired, but preferably should be placed so as to minimize the amount of edge pick-off region to an acceptable level. The “raised edge” prevents the ingress of air (and its oxygen gas component) to enter the ends of the wound film roll as it is a physical barrier preventing the diffusion of air through the wound ends of the film roll. This prevents the oxidation and formation of aluminum oxide in the metallized film past the “raised edge”; consequently, the heat sealant layer of the film layer beyond the “raised edge” is kept from being “activated”; and no or very little pick-off of the soft aluminum metal occurs past the “raised edge” (however, metal pick-off could occur in the area of the metallized film prior to the “raised edge” position). The “raised edge” should be formed while the film roll winds in vacuum within the metallizing chamber, prior to venting occurring.

FIG. 2 is a schematic view according to one of the embodiments of the invention in which a “raised edge” is formed using one of the embodiments or methods as described in the Examples. The “raised edge” is a narrow region of the film that is purposely distorted to form a “hump” or ridge aligned in the machine direction of the film which progressively builds up as the film layers wind on top of each other. This forms a hard ridge or “raised edge” which prevents the ingress of oxygen or air into the roll past said “raised edge.” Thus, no edge pick-off forms past the “raised edge.” Use of knurl wheels (or other methods such as tape) to form “raised edges” are best conducted under “soft winding” conditions (i.e. low tensions) to produce said “raised edges” but also reduce risk of film blocking and consequent breaking or tearing of the film.

The “raised edge” can be formed in any number of ways, as shown and described in the Examples, but should not be limited to only the Examples. These methods include, but are not limited to: using tapes or other strips attached to the metallizing chamber's cooling drum at the desired locations corresponding to the film edges; tapes or other strips attached to the rewinding core at the desired locations corresponding to the film edges; specially designed masking that is placed between the film substrate (as supported by the cooling drum) and the metal wire evaporation ceramic boats; electro-static “knurl” devices that electro-statically “pin” the film layers together in a specific lane located as desired to the proximity of the film edges; and mechanical “knurl” wheels that mechanically deform the film in a specific lane located as desired to the proximity of the film edge. These methods can be used alone or in combination of each other.

FIG. 12 illustrates some preferred locations for using these methods inside the metallizing chamber. FIG. 12 is a schematic of a cross-sectional view of the interior of a vacuum metallizing chamber showing the interior lay-out of a typical metallizer, the position of the unwind section, rewind section, coating (or deposition) chamber, aluminum wire, cooling drum, ceramic boats, aluminum vapor cloud, film substrate path, and the various methods for producing “raised edges” and their relative position within said chamber: taping of rewind core; taping of cooling drum; knurl wheel and backing wheel; and slotted masking plate.

In particular, the tape methods are very inexpensive and simple to use. Prior to metallizing the film substrate, 6 mm wide model striping tape (e.g. suitable type is Great Planes® Company KwikStripe™ brand or similar striping tapes made by 3M™) can be wrapped one or two times around the circumference of the metallizer's cooling drum at the masking edge approximately 1.75″ (44.45 mm) in from each edge of the cooling drum. (One edge/tape position is known conventionally as the “drive side” (DS); the other edge/tape position is known conventionally as the “pump side” (PS).) The heat sealable side of the BOPP substrate film is placed against the cooling drum and its taped edges such that the metal receiving surface faces the aluminum wire evaporation boats.

FIG. 3 is a schematic view illustrating the placement of tape on the metallizing chamber's cooling drum prior to metallizing the film according to one embodiment of the invention. The placement of the tapes distorts the film slightly on the cooling drum due to differential heat transfer; this slight distortion forms a “raised edge” on the film layers as they build up layer upon layer in the winding section. Placements or positions of the tapes on each side of the cooling drum are aligned so as to produce raised edges on the winding roll to restrict edge pick-off width as desired.

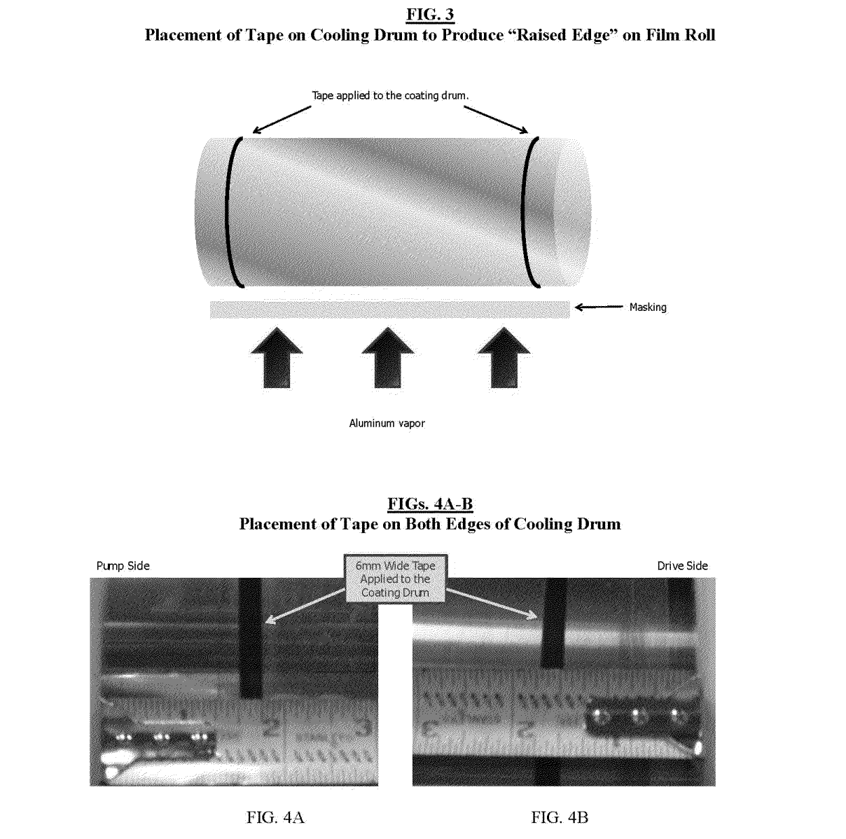

FIG. 4 is pictures showing actual placement of tapes on each end of the cooling drum in a metallizing chamber. “Pump side” and “Drive side” are convenient reference labels to describe and distinguish which side of the cooling drum is which and to maintain such consistent reference from one metallizing machine to another.

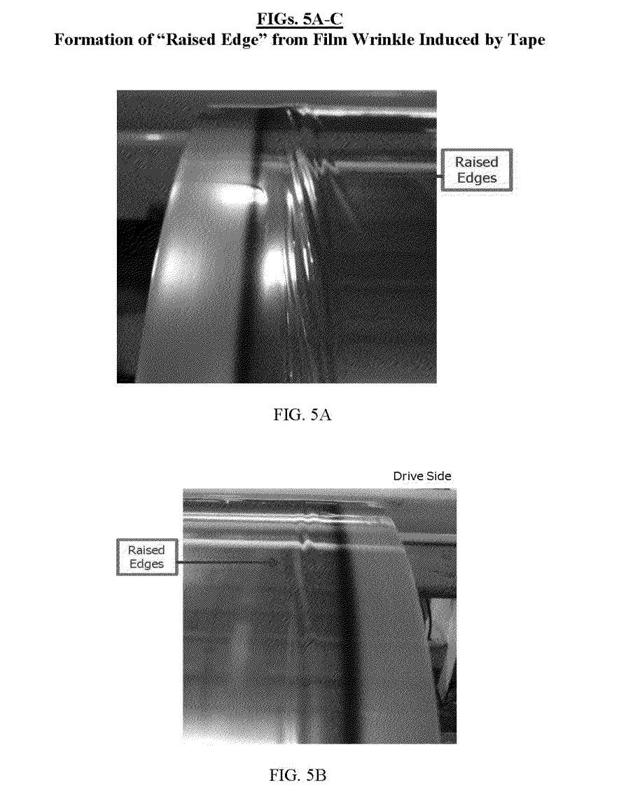

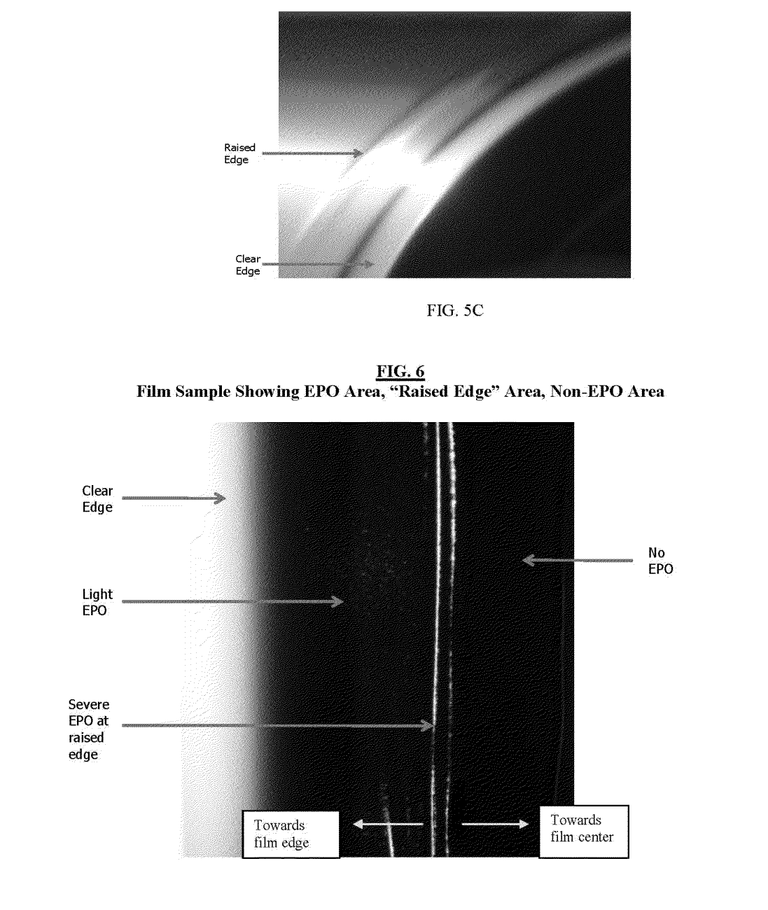

The film is metallized at the desired optical density (e.g. nominal 3.2 OD target). As the film is metallized, a wrinkle is formed on the cooling drum where the film is pressed against the taped region. This wrinkle builds-up on the rewinding film roll over successive film layers such that a “raised edge” is formed in the location of the taped area. FIGS. 5A, 5B, and 5C are pictures of “raised edges” formed by the embodiment utilizing tape as the method to form said raised edges. The high ridge of film can be seen on the edge of the wound film roll. Raised edges produced by other exemplary methods (e.g. knurl wheel and other methods described in Examples) have similar appearance.

This “raised edge” is a zone or band of film that is tightly compressed in that specific region around the circumference of the winding film roll. The “raised edge” acts as a barrier in which air cannot easily pass by. Thus, when the vacuum metallizing chamber is vented to atmosphere, air entering the ends of the film roll is blocked from further ingress by the “raised edge.” In this way, oxidation of the aluminum metal is restricted from occurring past said “raised edge” and edge pick-off effects are greatly reduced or eliminated by this method. For Example, FIG. 6 is a picture of a layer of metallized film on a light table illustrating the regions showing: clear unmetallized edge; edge pick-off area before the “raised edge”; raised edge region; and non-edge pick-off region after the raised edge region.

Another method can be to use tape or a strip of plastic around the circumference of the rewinding core prior to the freshly-metallized film being wound. By placing the tape or plastic strip at the desired locations respective to the rewinding film edges, a “raised edge” can be formed as the successive film layers build on one another. Preferably, a plastic strip ca. ¼ inch (6.4 mm) wide, ca. 1000 μm thick cast polypropylene film is used.

Another method to produce a “raised edge” is to use a specially designed masking plate which has a slotted end plate allowing a narrow band of metallized film within a clear unmetallized lane. This metallized “sacrificial strip” causes a dimensionally different film in that region due to the thermal load from the metal vapor deposition. This effectively produces an equivalent type of “raised edge” that inhibits the ingress of air into the edges of the film roll during chamber venting, and thus, helps prevent the formation of edge pick-off issues.

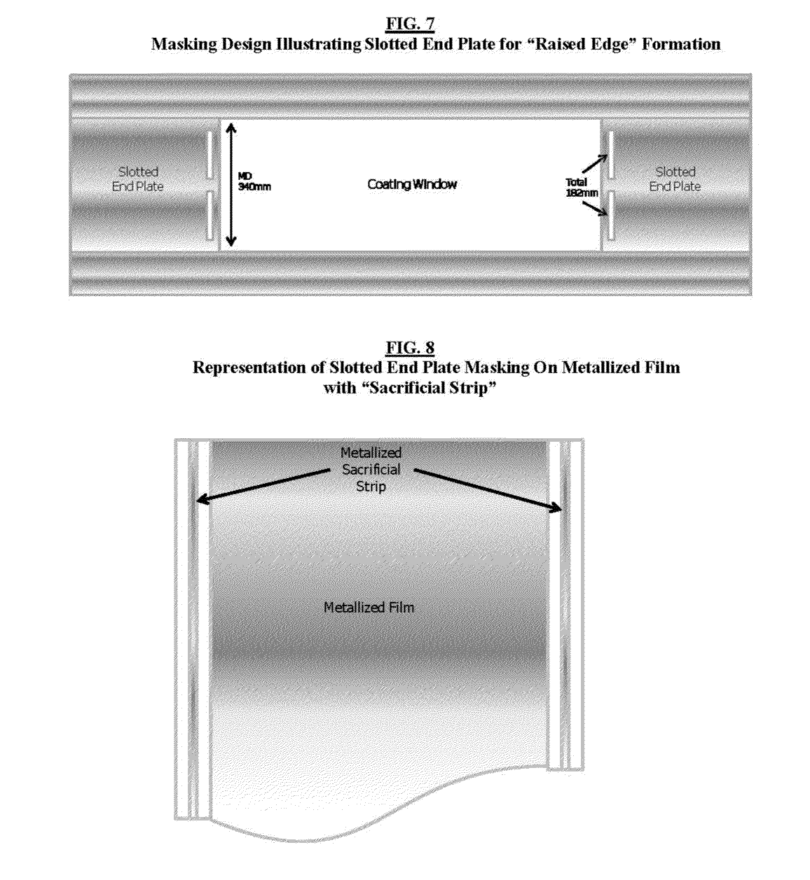

FIG. 7 is a schematic view of one of the embodiments according to the invention to produce “raised edges” using a modified masking design in which machined slots at each end of the masking plate will result in a narrow strip of metallized film at the desired edges. This metallized strip will form a “raised edge” as the film layers build up in the winding section.

FIG. 8 is a schematic view of the film using the modified edge masking design according to one embodiment of the invention. It illustrates the narrow strip of metallized film—banded on each side with a strip of clear unmetallized film—in which the strip of metallized film forms the “raised edge.” This strip of metallized film is also known as the “sacrificial strip” and would be slit off of the finished film roll product.

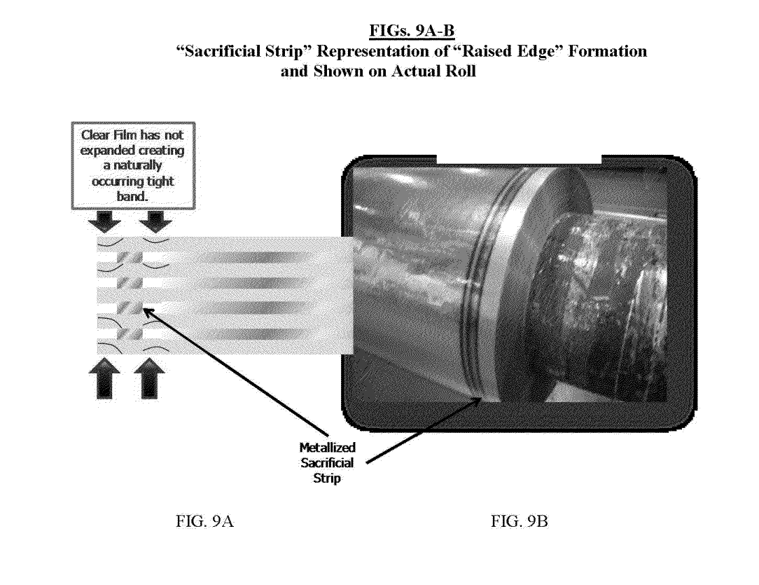

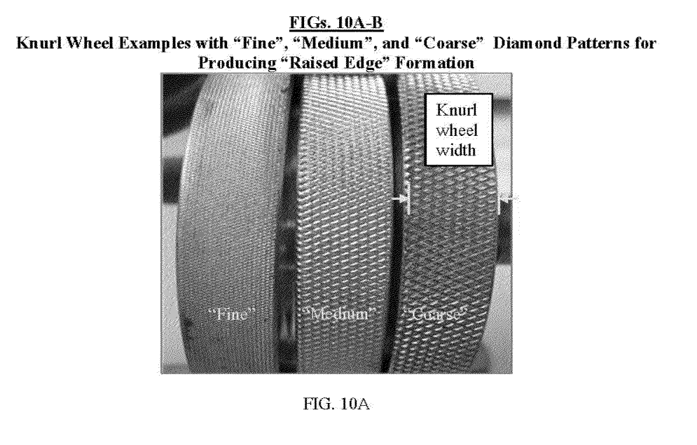

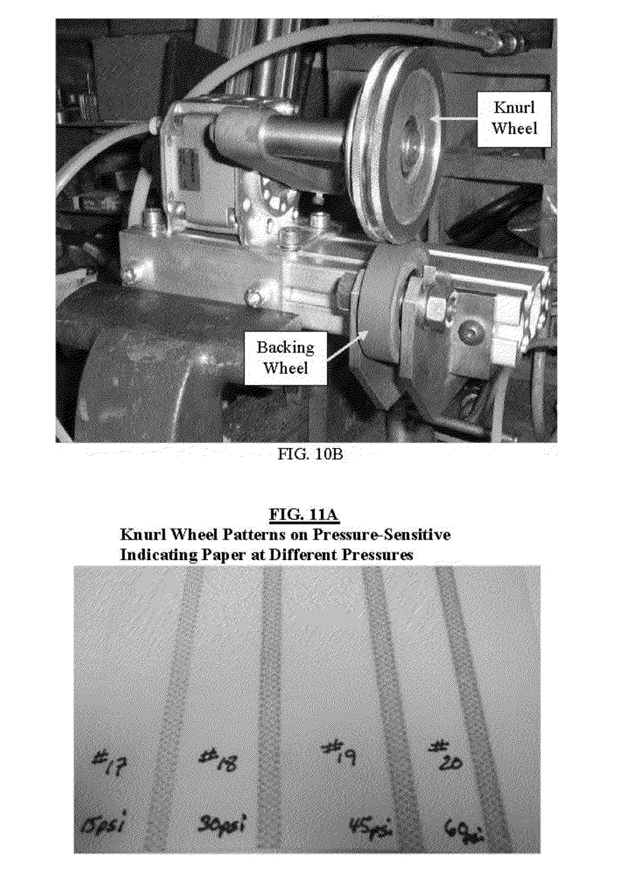

FIGS. 9A and 9B, respectively, is a schematic view of the “raised edge” formed by the “sacrificial strip” metallization using the embodiment of a slotted end plate masking design; and a picture of the actual “sacrificial strip” on one end of a rewound metallized film roll.

A particularly preferred method of producing “raised edges” is by the use of mechanical patterned knurl wheels and accompanying rubber-covered backing rolls. In this embodiment, knurl wheel-type equipment can be installed inside the chamber to produce a physical, intentional “raised edge” on either or both sides of the film width as desired. Such knurls can be installed between the unwinding section and the cooling drum/deposition station or, preferably, between the cooling drum/deposition station and the rewinding section, in order to make a “raised edge” after metal deposition. This knurl-type equipment can be used in place of or in addition to using the previously described methods of taping the cooling drum or rewind core, or using specially designed masking for a “sacrificial strip.” The knurl wheel is a roughened or grooved narrow roller; or roller with protuberances; which roughen or deform the film where the knurled roller is in contact. In general, the knurl wheel is a steel (or other durable material) wheel with a textured surface for “biting” into the film substrate.

Different textures or knurl patterns can be devised or used and optimized for the particular substrate type and thickness. Preferred pattern is a diamond pattern and more preferred was a “medium” diamond pattern (other diamond patterns are “coarse” and “fine”). The knurl wheel and an accompanying rubber-covered backing wheel can be installed between the unwind section and the cooling drum of the metallizing chamber, at one or both sides of the unwinding roll. Preferably, the knurl wheel and backing wheel can be mounted between the cooling drum and the rewind section.

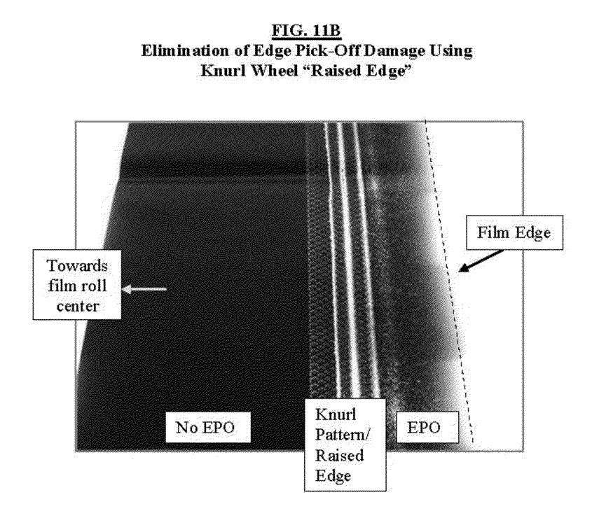

FIGS. 10A and 10B are pictures, respectively, of a mechanical knurl wheel to form a “raised edge” according to one embodiment of the invention. FIG. 10A shows representative knurl patterns of 3 different knurl wheels for example. FIG. 10B shows a knurl wheel with accompanying backing roll mounted inside the vacuum metallizing chamber between the rewinding section and the cooling drum where metal deposition upon the film substrate occurs.

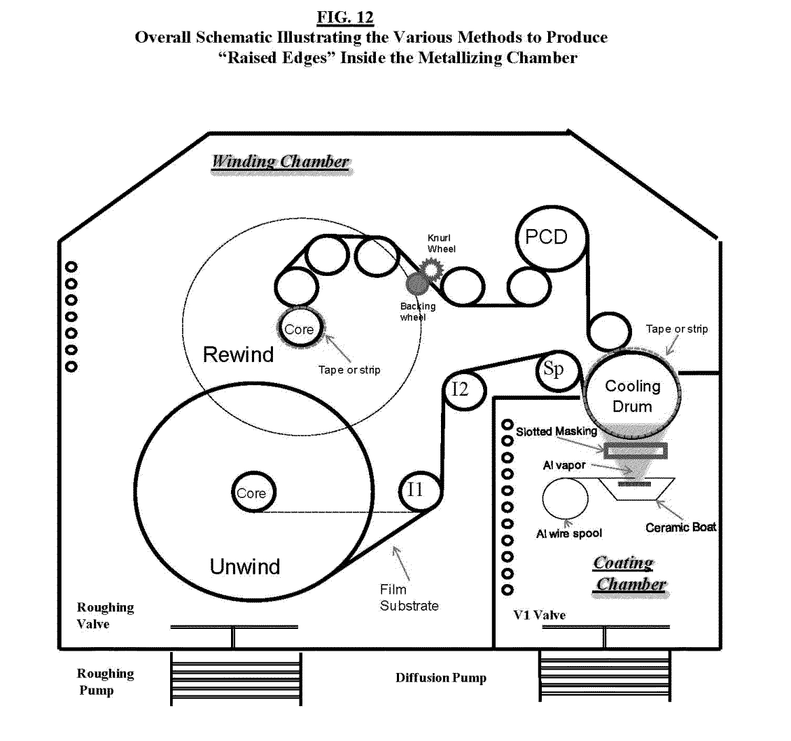

Any suitable location in these areas where space is available for these knurl assemblies can be used. The durometer of the backing wheel rubber may be from 60-90 durometer, preferred being about 60-70 durometer. The knurl wheels can either be single or double knurl wheels, the preferred being a single knurl wheel. The knurl wheels can be 5-10 mm in width, the preferred being 5 mm. The film substrate is passed between the respective knurl wheel and backing wheel; essentially, the film is nipped or pinched between the two wheels. The pressure of the knurl wheel pressing against the film (and backing wheel) can be adjusted as desired to increase or decrease the depth of the knurl pattern embossed onto the film surface. For example, FIG. 11A shows the knurl wheel patterns n pressure sensitive indicating paper at different pressures. Preferred pressure is 15-60 psi; more preferably about 45-60 psi. This knurl pattern embossment distorts the film in that area, causing a “raised edge” to form within the knurl pattern as the film layers build-up at the rewinding section and prevents edge pick-off from occurring. FIG. 11B shows the elimination of metal edge pick-off damage using the “raised edge” formed by a mechanical knurl wheel according to an embodiment of the invention.

In these manners, edge pick-off effects can be controlled and waste minimized, thus resulting in higher quality metallized rolls and higher productivity. In general, it is preferable that the tape, slotted end plate masking, or knurl be located within 0-6″ in (152.4 mm) from each edge of the film, more preferably, 0-3 inches (76.2 mm), and even more preferably 1-2″ (25.4-50.8 mm) in order to produce a “raised edge” that is located within 0-6″ in (152.4 mm) from each edge of the film, more preferably, 0-3 inches (76.2 mm), and even more preferably 1-2″ (25.4-50.8 mm). The height of the “raised edge” above the surface of the wound film roll (i.e. non-raised edge area of the film roll) is preferably about 0.5-3.0 mm for best effectiveness in minimizing ingress of air and reducing edge pick-off effect, and more preferably about 1.0-2.0 mm. A “raised edge” of less than about 0.5 mm height could be ineffective at reducing edge pick-off severity. Thus, the “raised edge” method can control the extent of the metal edge pick-off and severity and limit the amount of rejected or unacceptable product.

### EXAMPLES

A three-layer BOPP film was made using a 6-meter wide sequential orientation tenter process. The multi-layer BOPP film comprised: a core layer comprised of a crystalline isotactic propylene homopolymer; a coextruded heat sealable skin layer comprised of propylene-based random copolymer on one side of said core layer; and a coextruded metal receiving skin layer comprised of a crystalline isotactic propylene homopolymer and/or a crystalline isotactic “mini-random” propylene-based ethylene copolymer wherein the ethylene content was less than 1.0 wt % of the copolymer, on the side of the core layer opposite the heat sealable layer. These layers were combined via coextrusion through a multi-layer die, cast on a chill drum, oriented in the machine direction through a series of heated and differentially sped rolls, followed by transverse direction stretching in a tenter oven. The film was heat-set or annealed in the final zone of the tenter oven to reduce internal stresses and minimize heat shrinkage of the film and maintain a dimensionally stable biaxially oriented film. The side of the metal receiving layer opposite the heat sealable skin layer was discharge-treated via corona discharge treatment method, flame, atmospheric plasma, or preferably, corona discharge in a controlled atmosphere of CO₂ and N₂ (to the exclusion of O₂) after orientation (this latter discharge-treatment method results in about 0.3-0.5 atomic % of N-functional species that the other discharge-treatments do not typically result in). The BOPP film was wound in roll form. The BOPP roll was then slit into “master” rolls into widths suitable for the vacuum metallizing chamber, typically 3-meter wide rolls for a nominal 3-meter wide metallizer.

The afore-mentioned core layer was comprised of propylene homopolymers or copolymers of ethylene and propylene, or blends thereof. Preferably, propylene homopolymer was used or a “mini-random” ethylene-propylene copolymer in which the ethylene component was less than 1.0 wt % of the polymer. The core layer could be comprised of 80 wt % to 100 wt % semi-crystalline polypropylene with a specific isotacticity and optionally, 0 wt to 20 wt % modifiers such as EP copolymers and hydrocarbon resins. The core resin layer was typically 5 μm to 50 μm in thickness after biaxial orientation, preferably between 10 μm and 20 μm, and more preferably 15-17.5 μm. Semi-crystalline polypropylenes generally have an isotacticity≧90% as can be measured by ¹³C NMR spectra obtained in 1,2,4-trichlorobenzene solutions at 130° C. The % percent isotactic content can be obtained by the intensity of the isotactic methyl group at 21.7 ppm versus the total (isotactic and atactic) methyl groups from 22 to 19.4 ppm. Suitable examples of semi-crystalline polypropylenes for this invention were Total 3271 and 3270, and ExxonMobil PP4772. Typically, these resins have a melt flow rate of about 0.5 to 5 g/10 min., and the melting point of about 160-167° C. and a density of about 0.90-0.91 g/cm³. Optional modifiers to the core layer can include suitable hydrocarbon resins such as: Plastolyn® R1140 supplied by Eastman Chemical, OPPERA® PR100A supplied by ExxonMobil and Arkon® P-125 supplied by Arakawa Chemical (USA) Inc. These hydrocarbon resin grades were typically found as masterbatches comprising 50-60 wt % active hydrocarbon resin content of the masterbatch, with the carrier resin of propylene homopolmer. Preferred were hydrocarbon resins based on polydicyclopentadiene. A suitable amount of active hydrocarbon content in the core layer is from 0 wt % to 10 wt %.

The coextruded heat sealable layer can be comprised of propylene-based copolymers such as ethylene-propylene copolymers having a nominal ethylene content from about 1.0-20 wt % of the polymer, preferably 4.0-8.0 wt % ethylene; nominal melt flow rate at 230° C. of 1.0-20.0 g/10 min, preferably 4.0-10.0 g/10 min; nominal melting point of 100-150° C., preferably 130-145° C.; and density of 0.80-0.90, preferably 0.85-0.90. A suitable propylene-based copolymer can be those supplied by Total Petrochemicals as grades 8573 and 8473 ethylene-propylene copolymer. The heat sealable layer can also be comprised of a “terpolymer” of ethylene, propylene and butene having a nominal ethylene content of about 0.10-10 wt % of the polymer, preferably 1.5-5.0 wt %; nominal butene content of about 0.10-30 wt %, preferably 2.0-18.0 wt %; nominal melting point of 60-120° C., preferably 80-100° C.; and nominal density of about 0.80-0.90. Suitable heat-sealable terpolymer resins can be those produced by Sumitomo such as grades SPX78H8 or SPX79F1. Other suitable terpolymers can be those supplied by Lyondell Basell as Adsyl® grades 5C30F or 3C30F ethylene-propylene-butene terpolymers. The heat-sealable layer coextruded with the core layer may have a thickness after biaxial orientation between 0.2 and 5 μm, preferably between 0.6 and 3 μm, and more preferably between 0.8 and 1.5 μm. The heat-sealable layer may contain an anti-blocking agent and/or slip additives for good machinability and a low coefficient of friction in about 0.05-0.5% by weight of the heat-sealable layer.

The coextruded metal receiving layer deposed on the side of the core layer opposite the heat sealable layer can be comprised of propylene homopolymers, ethylene-propylene copolymers, ethylene-propylene-butene terpolymer, high density polyethylene, mini-random ethylene-propylene resin, or blends thereof. Preferably, mini-random polypropylene was used such as ExxonMobil PP4712, Total 3375HA, and Conoco Phillips CR027, comprising ethylene component in the range of less than 1.0 wt %, and preferably about 0.5-0.6 wt % of the resin. The melt flow rate of suitable mini-random polypropylenes was in the range of 2.5 to 5 g/10 min. and the melting point of suitable mini-random polypropylene was in the range of 155 to 165° C. The metal receiving layer may also be comprised of antiblocking agents of about 0.01 to 0.1 wt % of the layer, and preferably about 0.03-0.05 wt % for good machinability and a controlled coefficient of friction. The metal receiving layer coextruded with the core layer had a thickness after biaxial orientation between 0.2 and 5 μm, preferably between 0.6 and 3 μm, and more preferably between about 0.75 and 1.0 μm.

The coextrusion process included a three- or four-layered compositing die. In the embodiment of a 3-layer coextruded substrate, the polypropylene core layer was sandwiched between the metal receiving layer and the heat sealable layer. The resin layers were typically melt extruded at 220-260° C. The multilayer laminate sheet was cast onto a cooling drum whose surface temperature was controlled between 30° C. and 90° C. to solidify the non-oriented laminate sheet. The non-oriented laminate sheet was stretched in the longitudinal or machine direction (MD) at about 95 to 165° C. at a stretching ratio of about 4 to about 5 times the original length and the resulting stretched sheet was cooled at about 15° C. to 50° C. to obtain a uniaxially oriented laminate sheet. The uniaxially oriented laminate sheet was introduced into a tenter and preliminarily heated between 130° C. and 180° C., and stretched in the transverse direction (TD) at a stretching ratio of about 8 to about 10 times the original width and then heat-set or annealed to reduce internal stresses due to the orientation and minimize shrinkage and give a relatively stable biaxially oriented sheet (typically exhibiting nominally about 5-11% MD shrinkage and less than 8% TD shrinkage at a temperature of 140° C. for 15 minutes, substantially in accordance with ASTM D1894). The biaxially oriented film had a total thickness between 6 and 40 μm, preferably between 10 and 20 μm, and most preferably between 15 and 17.5 μm.

The slit BOPP master film roll was placed in a metallizing chamber and prepared for metallizing. The BOPP substrate film was then threaded through the metallizing line to the rewinding section. The heat sealable side of the BOPP substrate film was placed against the cooling drum; the metal receiving layer was facing the metal wire evaporation boats. Edge masking was typically used which comprised a cooled sheet metal template that was positioned between the cooling drum/film substrate and the ceramic boats, and guided deposition of the metal vapor onto the film substrate and prevented metal vapor deposition onto the cooling drum edges (which if they were not protected by the masking, would build-up with deposited metal and require frequent scraping and cleaning). The edge masking also typically left a clear, unmetallized border on both edges of the film substrate by design so as to ensure that the cooling drum was not exposed to metal deposition. The clear edge was typically about ¼ inch to ½ inch in width (6.4-12.7 mm).

Once the film was threaded up and the chamber pumped down to the required vacuum levels (typically about 1×10⁻⁴ ton (1.33×10⁻⁵ kPa)), vapor deposition of the aluminum was started. Aluminum wire of ca. 99.90% purity was used. The film was metallized at an optical density (OD) of 1.5-5.0, preferably 2.0-3.5, and more preferably at about 3.2 target OD; the vapor-deposited aluminum metal can have a thickness between 5 and 100 nm, preferably between 20 and 80 nm, more preferably between 30 and 60 nm. Operating linespeed of the metallizer was ca. 1800 fpm (549 mpm).

The roll was then removed from the metallizer rewind section, mounted onto a slitting machine and rewound and slit into customer-specified widths. The metallized roll was slit and rewound and edge pick-off severity was rated at selected intervals such as the beginning of the roll, middle of the roll, and end of the roll (near core).

### Example 1

Three-layer BOPP film substrate was made as described above, of nominal 70 G or 17.5 μm thickness after biaxial orientation. The heat sealable layer thickness was nominal 1.5 μm and the metal receiving layer was nominal 1.0 μm thickness after biaxial orientation. Prior to metallizing the film substrate, 6 mm wide model striping tape (Great Planes® Company KwikStripe™ brand) was wrapped around the circumference of the metallizer's cooling drum at the masking edge approximately 1.75″ (44.45 mm) in from each edge of the cooling drum. The heat sealable BOPP film substrate was threaded through the metallizer from the unwind section through to the rewinding section; the heat sealable side of the BOPP film substrate was placed in contact with the taped cooling drum. The film was metallized at an optical density of nominal 3.2 target. A “raised edge” was formed at the desired locations as the metallized film was rewound and its height was about 2.6 mm average. Upon completion of metallizing, the rewound metallized roll was then removed from the metallizer rewind section, mounted onto a slitting machine and rewound and slit into customer-specified widths. The “raised edge” portion was slit off and discarded. Approximately 46,000 linear feet (14,024 meters) of the metallized roll was slit and rewound and edge pick severity was rated at selected intervals such as the beginning of the roll, middle of the roll, and end of the roll (near core).

### Example 2

The multi-layer BOPP film of Example 1 was used and metallized except that a 97,000 linear feet (29,573 m) roll was used instead. The “raised edge” height was measured and averaged about 3.0 mm.

### Example 3

The multi-layer BOPP film of Example 1 was used and metallized except that no model striping tape was used. In this Example, the “raised edge” was made using a specially designed edge masking design which had a slotted end plate allowing a narrow band or strip of metallized film within each of the clear unmetallized edges on each side of the metallized film substrate (FIGS. 7-9). This metallized “sacrificial strip” caused a similar type of “raised edge” to form as in Examples 1 and 2. The “raised edge” height by this method was measured as about 0.5 mm average.

### Example 4

The multi-layer BOPP film of Example 1 was used and metallized except that no striping tape was used on the cooling drum. In this Example, the “raised edge” was made by taping ca. ¼ inch (6.4 mm) wide, ca. 1000 μm thick cast polypropylene film strips onto the rewinding core prior to rewinding of the metallized film. As the metallized film layers built up on the core, these strips caused a wrinkle to form on the film in the same location as said strips, forming the “raised edge”. These strips were positioned such that the “raised edge” was formed about 1.75 inches (ca. 44.45 mm) in from the pump side and drive side edges of the film. The “raised edge” height was measured as about 2.7 mm average.

### Example 5

The multi-layer BOPP film of Example 1 was used and metallized except without taping the cooling drum. Instead, the “raised edge” was formed by using a mechanical knurl wheel and an accompanying rubber-covered backing wheel which were installed at the unwind section of the metallizing chamber on both sides of the unwinding roll. In this Example, a 5 mm wide single knurl wheel with “medium” diamond pattern was used in conjunction with a 70 durometer rubber backing wheel, and a nip pressure of about 45 psi. The “raised edge” formed measured about 1.0 mm average.

### Comparative Example 1

The multi-layer BOPP film of Example 1 was used and metallized except without taping the cooling drum. No “raised edge” was formed.

### Comparative Example 2

The multi-layer BOPP film of Example 2 was used and metallized except that the “raised edge” height was less than 0.5 mm, about 0.2 mm average.

Table 1 summarizes the results of the Examples and Comparative Examples for edge pick-off severity and width.

TABLE 1

| | Raised | EPO Severity Rating | | | EPO width | | |
|---|---|---|---|---|---|---|---|
| | Edge | (1.0 = excellent, 4.0 = poor) | | | inches (mm)/side | | |
| | Height | Start of | Middle of | End of | Start of | Middle of | End of |
| | (mm) | roll | roll | roll | roll | roll | roll |
| Ex. 1 | 2.6 | 1.0 | 1.0 | 1.0 | 1.0 (25.4) | 2.0 (50.8) | 1.5 (38.1) |
| Ex. 2 | 3.0 | — | — | 1.0 | — | — | 2.0 (50.8) |
| Ex. 3 | 0.5 | 1.0 | 2.0 | 2.0 | — | — | 2.5 (63.5) |
| Ex. 4 | 2.7 | 1.0 | — | 1.0 | 1.75 (44.5) | — | 2.0 (50.8) |
| Ex. 5 | 1.0 | 1.0 | 1.0 | 1.0 | 1.5 (38.1) | — | 2.2 (55.6) |
| CEx. 1 | 0 | 1.0 | 2.0 | 3.5 | 2.5 (63.5) | 3.0 (76.2) | 3.5 (88.9) |
| CEx. 2 | 0.2 | — | — | 4.0 | — | — | 3.75 (95.25) |

As Table 1 shows, Example 1 (Ex. 1) was a metallized BOPP film made as described above at a nominal optical density target of 3.2. 6 mm wide model striping tape was attached to the circumference of the cooling drum in two locations, each 1.75 inches (44.45 mm) in from each edge of the cooling drum. The BOPP basefilm roll was metallized and wound; it was then removed from the metallizing chamber and rewound on a slitting machine. Edge pick-off was evaluated at the start of the roll (ca. 3000-5000 ft (915-1525 m)), middle of the roll (ca. 20,000 ft (6097 m)), and end of the roll, near the core (ca. 45,000 ft (13,720 m)) by noting the amount and degree of edge pick-off forming past the “raised edge” (i.e. edge pick-off observed beyond the “raised edge” towards the center portion of the film width). Edge pick-off width was measured as well as severity rating. EPO severity past the “raised edge” region was very good for Example 1, rating a 1.0 “Excellent”, indicating very little to no metal pick-off noted. Where edge pick-off was noted, the width on each edge of the film was 2.0 inches (50.8 mm) or less throughout the roll and primarily found in the portion of the metallized film between the film edge and the “raised edge”.

Comparative Example 1 (CEx. 1) was a metallized BOPP control film made as described above at a nominal optical density target of 3.2 except that no tape was used on the cooling drum to induce a “raised edge.” Edge pick-off was evaluated in the same manner as Ex. 1. In CEx. 1, edge pick-off worsened as the roll was unwound towards the core: The outer wraps of the roll started with a good EPO rating of 1.0 and an EPO band of 2.5 inches (63.5 mm) wide on each film edge; however, as the roll progressed to near the core, EPO severity and width worsened to a 3.5 rating (poor or heavy pick-off) and 3.5 inch (88.9 mm) wide EPO lane on each film edge.

Example 2 (Ex. 2) and Comparative Example 2 (CEx. 2) were made substantially the same as in the above Example 1 except a 97,000 linear feet roll was used (29,573 m). Ex. 2 was produced using a sufficiently high “raised edge” that controlled EPO lane width to 2.0 inches (50.8 mm) on each film edge and an EPO severity rating of 1.0 (“Excellent”) near the core. However, CEx. 2 was made with a “raised edge” that was too low or not sufficiently high enough to prevent ingress of air into the edge portion of the film roll. Thus, CEx. 2 has a worse EPO lane width of 3.5 inches (ca. 89 mm) on each film edge and EPO rating of 4.0 (“Poor”) near the core. This pair of Example and Comparative Example shows that the “raised edge” must be of a sufficient height to be effective as an EPO reduction method.

Example 3 (Ex. 3) was an alternative method to Examples 1 and 2 to build a “raised edge.” This example used a specialized masking design which had a slotted end plate allowing a narrow band of metallized film within a clear unmetallized lane (FIGS. 7-9). This metallized “sacrificial strip” caused a dimensionally different film in that region due to the thermal load from the metal vapor deposition. This effectively produced an equivalent type of “raised edge” that inhibited the ingress of air into the edges of the film roll during chamber venting, and thus, helped prevent the formation of edge pick-off issues. Evaluation of EPO severity during this test was found to be good at a 2.0 rating near the core and edge pick-off width averaged about 2.5 inches (63.5 mm).

Example 4 used a strip of cast polypropylene film on each side of the rewinding core prior to metallized film rewinding in lieu of taping the cooling drum. It produced a satisfactory “raised edge” and EPO width was noted to be about 2.0″ (50.8 mm) or less per side average, and EPO severity rating was about 1.0 (“Excellent”) near the core.

Example 5 used a mechanical knurl wheel to form the “raised edge”. The EPO width and severity were acceptable, with excellent severity ratings throughout the roll diameter and EPO width acceptable. It was noted that the majority of EPO occurred within the film area between the film edge and the “raised edge”.

The above examples should be considered as illustrative of the invention and not restrictive. The invention can be applied to other polymeric film substrates in addition to BOPP, such as oriented polyethylene terephthalate (OPET), oriented high density polyethylene (OHDPE), oriented polystyrene (OPS), biaxially oriented nylon (BON), oriented polylactic acid (OPLA), or other polymer types and systems suitable for high speed vapor deposition of metal.

### Test Methods

The various properties in the above examples were measured by the following methods:

Edge pick-off severity evaluation: Film samples of the edge regions of the roll of interest are taken. Individual sheets of film are measured for optical density in the edge pick-off region using a Tobias Associates model TBX transmission densitometer. Optical density is a representation of a material's light blocking ability under specific conditions. Optical density is reported in terms of a logarithmic conversion. For example, a density of 0.00 indicates that 100% of the light falling on the sample is transmitted. A density of 1.00 indicates that 10% of the light is being transmitted; 2.00 is equivalent to 1%, etc. For edge pick-off severity evaluation, the optical density of the edge pick-off area is compared to the optical density of a non-edge pick-off area (e.g. the center portion of the film width) and the following rating scale is used based on the relative optical density between the edge pick-off area and the non-edge pick-off area:

1.0=Excellent (edge area optical density equals 98-100% of the optical density of center area)

2.0=Good (edge area optical density equals 94-97% of the center area optical density)

3.0=Fair (edge area optical density equals 90-93% of the center area optical density)

4.0=Poor (edge area optical density equals 89% or less of the center area optical density)

Several measurements may be made of the film sample in different spots and results averaged. For the Examples with “raised edges”, the metallized film area adjacent to the “raised edge” was tested (i.e. the film area just past the “raised edge” region towards the center of the film width in the transverse direction). Preferred values for EPO severity is 1.0-2.0, with a maximum rating of 3.0 for acceptability. 4.0 rating is unacceptable.

Edge pick-off width: The width of the edge pick-off lane is measured with a ruler or tape measure from the edge of the film to where the edge pick zone ends in the transverse direction of the film. Placing the film sample on a light table helps to determine where the edge pick-off lane begins and ends. Edge pick-off width is measured on each side. Several measurements can be made per side and an average calculated. Preferred maximum width is 1.5 inches (38.1 mm) per side; 2.5 inches (63.5 mm) per side is maximum width acceptable. Greater than 2.5 inches width is deemed unacceptable. In particular, in the cases where a “raised edge is used or formed, it is preferable that the EPO width is contained within the area of film contained by the physical edge of the film and the “raised edge” formation. Where EPO occurs in the film region past the “raised edge” formation, it is preferable that the EPO severity is 1.0-2.0 rating.

“Raised Edge” height: Height of the raised edge is measured by using a caliper such as a Mitutoyo America Corporation Absolute™ Digimatic™ caliper. The end of the caliper is placed against the film roll surface and the height of the “raised edge” is measured above the bulk film roll surface. Several measurements may be taken around the circumference of the finished metallized roll and an average height reported. Preferred height is 0.5-3.0 mm, more preferably 1.0-2.0 mm. A “raised edge” of less than 0.5 mm height could be insufficient to reduce EPO effects.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A method of reducing edge pick-off on a metallized polymeric film comprising:
creating a raised edge on at least one edge of a metallized polymeric film,
wherein,
a. edge pick-off severity is 3.0 rating or less; and
b. edge pick-off width is 2.5 inches or less.

2. The method of claim 1, wherein the raised edge is 0.5-3.0 mm in height above a non-raised surface of the metallized polymeric film roll.

3. The method of claim 1, wherein the metallized polymeric film comprises a metal layer having an optical density of the metal layer is 1.5-5.0.

4. The method of claim 1, wherein creating the raised edge comprises placing tape around a circumference of a cooling drum.

5. The method of claim 1, wherein creating the raised edge comprises placing a tape or strip around a circumference of a rewinding core.

6. The method of claim 1, wherein the raised edge is created using a slotted edge masking plate.

7. The method of claim 1, wherein the raised edge is created by mechanical knurling.

8. The method of claim 1, wherein the raised edge is created by static electricity knurling.

9. A metallized polymeric film with reduced edge pick-off comprising:
a polymer layer;
a metal layer on the polymer layer; and
a raised edge on a least one edge of the metal layer,
wherein the metallized polymeric film has an edge pick-off severity rating of 3.0 or less, and an edge pick-off width of 2.5 inches or less.

10. The film of claim 9, wherein the raised edge is 0.5-3.0 mm in height above a non-raised surface of the metallized polymeric film roll.

11. The film of claim 9, wherein the metallized polymeric film comprises a metal layer having an optical density of the metal layer is 1.5-5.0.

12. The film of claim 9, wherein creating the raised edge comprises placing tape around a circumference of a cooling drum.

13. The film of claim 9, wherein the raised edge is created by placing a tape or strip around a circumference of a rewinding core.

14. The film of claim 9, wherein the raised edge is created using a slotted edge masking plate.

15. The film of claim 9, wherein the raised edge is created by mechanical knurling.

16. The film of claim 9, wherein the raised edge is created by static electricity knurling.
